(19) United States
(12) Patent Application Publication
(10) Pub. No.: US 2018/0096361 A1
(43) Pub. Date: Apr. 5, 2018

(54) RECONCILE OF LICENSE ENTITLEMENTS BY CONTENTION

(71) Applicant: FLEXERA SOFTWARE LLC, Itasca, IL (US)

(72) Inventors: Ryan Richardson Gilchrist, Melbourne (AU); Paul Gerard Hughes, Melbourne (AU)

(21) Appl. No.: 15/286,170

(22) Filed: Oct. 5, 2016

(51) Int. Cl. G06Q 30/00; G06F 21/10

(52) U.S. Cl. CPC G06Q 30/0185; G06F 2221/0768; G06F 21/105

(57) ABSTRACT

Various embodiments are described herein that relate to mechanisms and techniques for discovering compliance license positions for a licensee. For example, heuristics could be used to discover the optimal compliance license position for the licensee. The heuristics may consider the contention of multiple software license entitlements and the need of each possible assignment. The contention for an entitlement generally increases as the number of possible installation assignments increases and as the number of available installations decreases, while the need of an assignment represents how important it is for an installation to be assigned to a specific entitlement. Installations that can be assigned to more entitlements (i.e., have more possible assignment options) will generally have less need to be assigned to the specific entitlement.

### RELATED FIELD

Various embodiments relate generally to software licensing. More specifically, various embodiments relate to computing systems, methods, and programs for discovering compliant license positions.

### BACKGROUND

A software license is a legal instrument that specifies the terms and conditions governing the use or redistribution of software. More specifically, a license grants a licensee permission to use one or more copies of software in ways that would ordinarily infringe upon the software owner's exclusive rights. Some licensees (e.g., enterprises) require licenses for multiple software assets during the ordinary course of business.

The term “entitlement” is used to refer to the licensee's legal right to use these software assets, which may be purchased from one or more licensors. An entitlement allows an installation of a corresponding software asset, and the entitlement will typically include conditions or limits on the use of the corresponding software asset. For example, a license entitlement may allow 100 installations of Microsoft® Office 2012 Professional that have downgrade rights.

Licensees have traditionally struggled to assign installations of entitlements in a manner that maximizes the value to the licensee. Although value may be represented as multiple goals that differ in priority from licensee to licensee, the primary goal is often to minimize the penalties caused by noncompliant installations of software, such as unlicensed installations and improperly assigned installations/entitlements. Further optimization (e.g., maximizing the number of unassigned installations) may be a secondary goal (though that goal will not be achieved at the expense of a compliant license position). While licensees would like to achieve a compliant license position that has no penalties, identifying and maintaining compliant licensing positions is becoming increasingly difficult due to the increased complexity of licensing models.

### SUMMARY

Introduced herein are techniques for finding compliant license positions for a licensee. More specifically, techniques are described herein for discovering how software installations of an entitlement should be assigned to one or more computing devices. The aim of entitlement reconciliation is to find one or more combinations of entitlement assignments to installations that maximize the value to the licensee. For example, some embodiments pertain to discovering the optimal compliant license position providing the highest value to the licensee. Oftentimes, one of the primary goals of the techniques described herein is to minimize the penalties caused by noncompliant installations of software, such as unlicensed installations and improperly assigned assignments/entitlements.

Over-aggressive optimization can sometimes result in a noncompliant license position, even when a compliant license position exists. Moreover, the optimal compliant license position may not necessarily be the same as the optimal license position (e.g., when the optimal license position is determined as a function of cost). For example, a low-cost assignment of an installation of an entitlement may cause a higher-cost assignment having fewer license entitlement options to miss out, thereby resulting in a noncompliant license position. The lower-cost assignment may have found another license entitlement option had the higher-cost assignment been made first. Such a scenario often occurs when a licensee is entitled to multiple assignments of the same software with downgrade rights (i.e., lower versions of the software typically have more license entitlement options than higher versions of the software, though higher versions are normally assigned first).

Various embodiments described herein utilize heuristics for discovering the optimal compliant license position for a licensee (e.g., an end-user or enterprise). More specifically, a particular software installation can be properly assigned based on the contention of multiple entitlements of a software license. Contention generally increases as the number of possible installation assignments increases and as the number of available entitlement installations decreases.

In some embodiments, the heuristics also consider the need of each possible installation assignment. The “need” of an installation assignment represents how important it is for an installation to be assigned to a specific entitlement or user. Consequently, installations that can be assigned to more computing devices (i.e., have more possible assignment options) will generally have less need to be assigned to the specific user.

### BRIEF DESCRIPTION OF THE DRAWINGS

FIG. 1 is a system-level diagram of a software licensing and distribution model.

FIG. 2 depicts a summary of an example entitlement for a licensee.

FIG. 3 includes a high-level flow diagram of a license optimization process.

FIG. 4 depicts a process for calculating the contention of possible assignments of license entitlements.

FIG. 5 depicts a process for calculating the need of possible installation assignments for each entitlement.

FIG. 6 depicts the results of a simulation that included three different optimization models.

FIG. 7 is a block diagram illustrating an example of a processing system in which at least some of the operations described herein can be implemented.

### DETAILED DESCRIPTION

Various embodiments are described herein that relate to mechanisms and heuristics for discovering compliant license positions for a licensee (e.g., an end-user or organization). More specifically, various embodiments relate to techniques for finding the optimal compliant license position based on the contention of all possible assignments of installations allowed by a software license and the need of each possible installation assignments.

The techniques described herein represent optimization techniques for processing entitlement information and executing licensed software asset(s). Accordingly, implementation of such techniques improves the processing capabilities of the computing device(s) that execute the licensed software asset(s) governed by the entitlement, as well as the licensing server responsible for assigning installations to entitlements.

### General System Overview

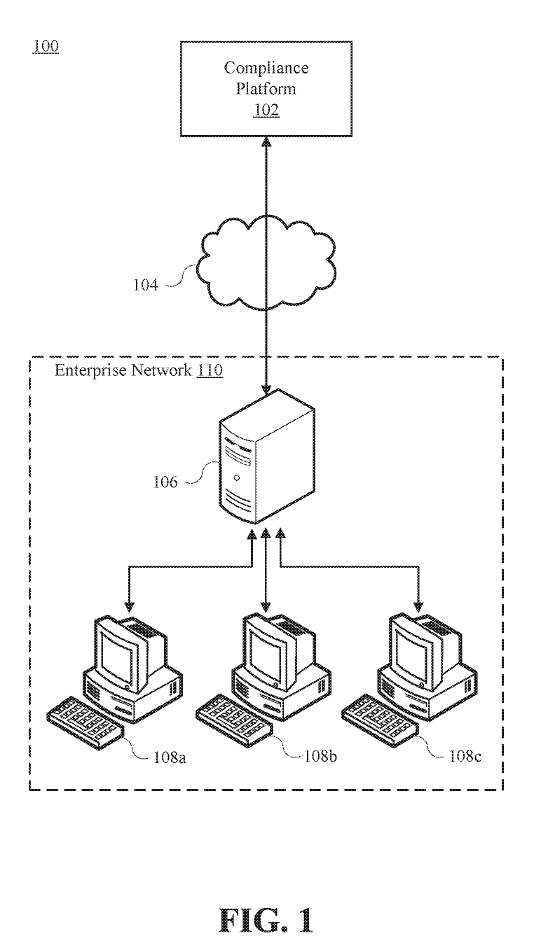

FIG. 1 is a system-level diagram of a software licensing and distribution model. The hallmark of software licenses is that a licensor (e.g., the software developer, publisher, or distributor) grants a licensee (e.g., an individual or enterprise) the right to use copies of software. The license agreement includes terms that define the authorized uses of the software, such as the number of installations allowed and the terms of distribution.

Software is often licensed to the licensee based on one or more criteria, such as the total number of computing devices/installations, the total (expected) usage, the desired feature(s), etc. For example, Software as a Service (SaaS) applications are often licensed to licensees on a subscription basis. When the licensee is an enterprise, the licenses are typically made accessible to one or more computing devices 108a-c associated with the enterprise. The computing device(s) 108a-c could include, for example, mobile phones, tablets, or personal computers (e.g., laptop computers or desktop computers) that are owned or operated by employees of the enterprise.

As shown in FIG. 1, the licenses may be locally hosted on a license server 106 residing within an enterprise network 110. Additionally or alternatively, the licenses may be remotely hosted by the licensor (or some other third party) on a remote license server accessible to the computing devices 108a-c across an external network, such as the Internet, a local area network (LAN), a wide area network (WAN), a point-to-point dial-up connection, etc. When software is needed by a computing device (e.g., computing device 108a), the computing device submits a request to the license server 106 for a license for the software.

The software (and, thus, licenses) required by each computing device may vary based on the corresponding user's role within the enterprise. For example, computing device 108a may request a license for an application having a first feature, while computing device 108b may request a license for the same application having a second feature. Computing device 108c, meanwhile, may request a license for a completely separate application. One skilled in the art will recognize that assigning installations of software to individual users (e.g., employees of an enterprise) or computing devices (e.g., personal computers and servers) and monitoring compliance with the license become increasingly difficult as the software licensing and distribution model becomes more complex. Although examples are provided herein based on user entitlements and computing device entitlements, entitlements could be based on other criteria as well (e.g., a number of products produced by the licensee).

Accordingly, in some embodiments a compliance platform 102 is responsible for monitoring license compliance by the enterprise. The compliance platform 102 may communicate with the license server 106 and/or the computing devices 108a-c.

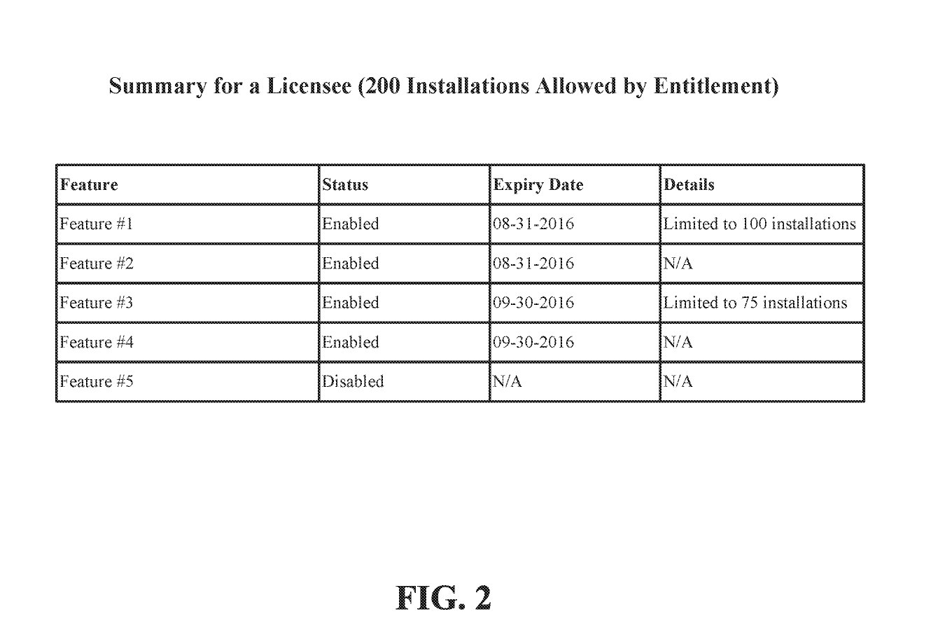

FIG. 2 depicts a summary of an example entitlement for a licensee. As noted above, an entitlement is a right to use software that is granted to the licensee when the licensee purchases a copy of the software from a licensor. This right to use the software is often accompanied by conditions or limits.

For example, the example summary shown here is for 200 installations of software having five different features. Each feature may be separately manipulable for individual installations of the software. Four of these features are currently enabled for at least some of the installations, while one feature is currently disabled for all of the installations.

Each feature may also have different limitations on scope and usage. For example, the enabled features may be associated with different expiry dates. Features could also be limited in terms of the time, usage, breadth, or depth of usage. For example, feature #1 and feature #3 are limited to 100 and 75 installations of the software, respectively. In some instances, the license allows the licensee to seamlessly add installations to the entitlement/license, remove installations from the entitlement/license, and/or modify an existing entitlement (e.g., by enabling or disabling features).

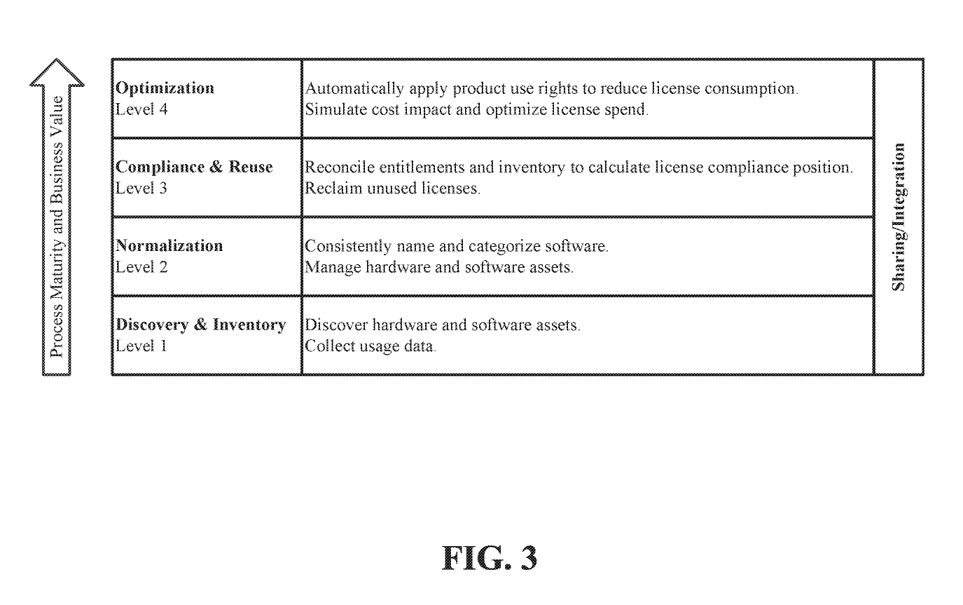

FIG. 3 includes a high-level flow diagram of a license optimization process. Such a process is often performed to ensure compliance by a licensee and to optimize licensee spending on software. Proper management of software assets can increase the business value of licensed software and result in a higher return on investment for the licensee.

Software asset management techniques can be used to manage all types of software and licensing models, as well as to reconcile license entitlements that have been purchased by the licensee. These techniques may also enable for manually or automatic checking for available installations of an entitlement as soon as a request is made for software (e.g., by a computing device or a licensing server), thereby proactively ensuring license compliance. In some embodiments, software asset management techniques are used as part of an automated reclamation process that allows the utilization of allowed installations to be maximized.

Software asset management techniques enable varying levels of management, including:
Discovery and Inventory: Discovery and inventory capabilities support integration with tools for collecting hardware and software inventory data, which is used to provide better visibility of the licensee's hardware and software assets.
Normalization: Normalization capabilities can provide normalized software inventory per licensee computing device and assure standard naming conventions are used to identify software families and software versions. This data could be used to identify unauthorized software residing on the licensee's computing devices, provide a more complete view of installed software, and develop a model for license compliance and optimization.
Compliance and Reuse: Compliance and reuse capabilities allow the licensee to calculate an accurate license compliance position and streamline license management processes through full or partial automation. Effective software reuse procedures (e.g., through automated license reclamation) may help eliminate new purchases of unnecessary entitlements.
Optimization: Optimization capabilities enable automatic application of complex entitlements (e.g., product use rights or product terms) to reduce license consumption and reduce software costs. Effective optimization also allows the licensee to select the most appropriate entitlement(s) to meet the licensee's needs at the lowest cost.

Effective software asset management techniques allow the licensee to realize many technical and business benefits, such as improved operational efficiencies, streamlined software licensing processes, and optimized software spend. Optimization may also allow the licensee to:
Minimize consumption of noncompliant entitlements;
Reduce ongoing software spend on unnecessary licenses; and
Reduce the time and effort required for managing licenses and monitoring compliance.

However, the complexities of many modern licensing models make it difficult or impossible for traditional software asset management tools to ensure continuous license compliance. For example, traditional license models are often simplistic (e.g., based on a single user or device per license), while modern licensing models may have complex and varied metrics (e.g., second-use assignments and more complicated installations).

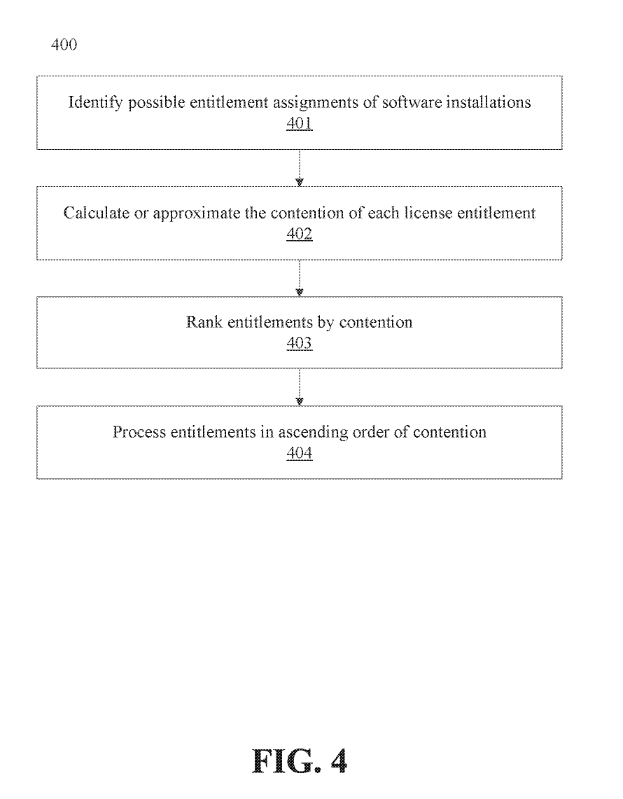

FIG. 4 depicts a process 400 for calculating the contention of possible assignments of installations allowed by an entitlement. Multiple possible entitlement assignments are initially identified for each software installation (step 401). When the licensee is an enterprise, the installation may be a physical installation of software or usage of a physical installation inside an enterprise or hosted by an enterprise. In some embodiments, every possible license entitlement assignment for a given software installation is identified. The possible assignments can include, for example, single installations, second-use assignments, and more complicated assignments (e.g., for virtual machine clusters). There are normally ten or fewer possible assignments for each software installation; however, in some instances, the number of possible assignments is greater than ten.

The contention can then be calculated or approximated for each license entitlement (step 402). Contention considers the number of possible assignments that can be made and the quantity of installations allowed by the entitlement. For example, one sample heuristic is:

$$Contention = \frac{Total Number of Possible Assignments}{Total Entitlement Quantity}$$

In some embodiments, the entitlements are ranked by contention (step 403). Ranking the entitlements by contention allows those entitlements having the lowest contention values to be addressed first (i.e., to those entitlements having the least contention are processed first to free up contention). The entitlements are then processed in ascending order of contention (step 404). Because those entitlements having the lowest contention are processed first, there is a higher chance that the assignment will help find a compliant license position.

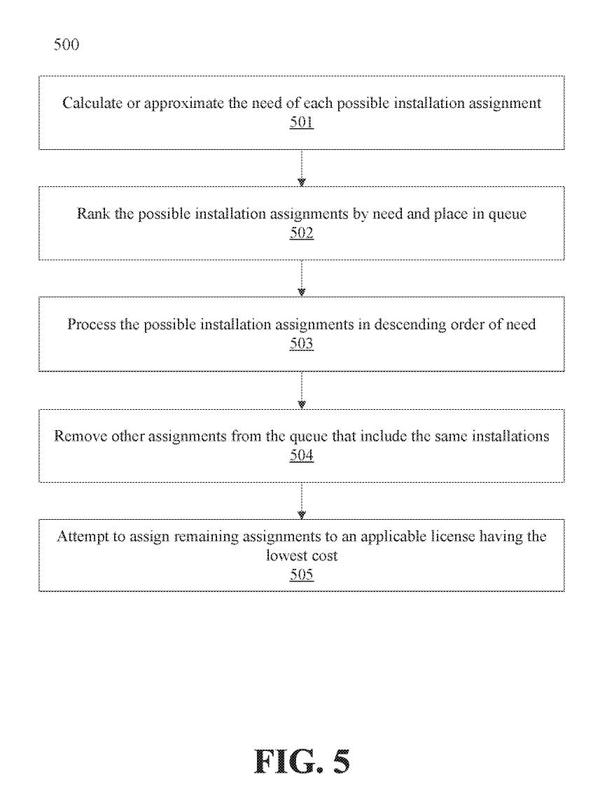

FIG. 5 depicts a process for calculating the need of possible installation assignments for each entitlement. The need of each possible installation assignment is initially calculated or approximated (step 501). Need is generally based on the entitlement quantity required by the assignment and the number of applicable entitlements having that quantity available. For example, one sample heuristic is:

$$Need = \frac{Entitlement Quantity Required for Assignment}{Total Number of Entitlements Having Quantity Available}$$

In some embodiments, the possible installation assignments are ranked by need and placed in a queue (step 502). Ranking enables those assignments having the highest need to be made first. The possible installation assignments can then be processed in descending order of need (step 503). Other assignments in the queue that include the same installations can then be removed or skipped (step 504). This is done to ensure that the quantity or limits of the entitlement are not broken at any point in time. Said another way, removal of those assignments ensures that offending assignments are skipped in the queue so that the licensee remains in compliance with the license. In some embodiments, a secondary criteria for determining assignment cost may be used to help optimize the result without placing compliance in jeopardy (and also to reduce the work required by subsequent optimization). For example, a compliance platform may specify that a second-use assignment “costs” half as much as a single installation assignment, or that the assignments should be sorted based on whether the assignments were previously assigned to the entitlement.

The set of one or more assignments produced by the process 500 constitutes a compliant license position. In some embodiments, an indication of the set of one or more assignments is transmitted to a license server (e.g., by a compliance platform). However, there may be assignments in the queue that were skipped and are still unlicensed (i.e., are prohibited by the entitlement). For each assignment that has been skipped or removed from the queue, an attempt can be made to minimize the compliance breach by assigning the assignment to an applicable license having the lowest cost (step 505). Although the final license position is not compliant in such scenarios, the compliance breach can be restricted to those software installations that are the cheapest to acquire.

Unless contrary to physical possibility, it is envisioned that the steps described above may be performed in various sequences and combinations. For example, the steps could be performed by a licensing server, a compliance platform, or distributed amongst the licensing server and the compliance platform. Additional steps could also be included in some embodiments.

### Reconcile Simulation

Simulations were performed for 5 different license entitlements of 100 installations each. The 5 different licenses were for 5 different versions of a software application, and the 500 total installations included 250 standalone installations and 250 second-use installation pairs. These parameters were used to simulate a complex licensing model for which continuous license compliance is difficult to achieve. Accordingly, the goal of the simulation was to find an exact fit for all of the license entitlements while remaining in a compliant license position.

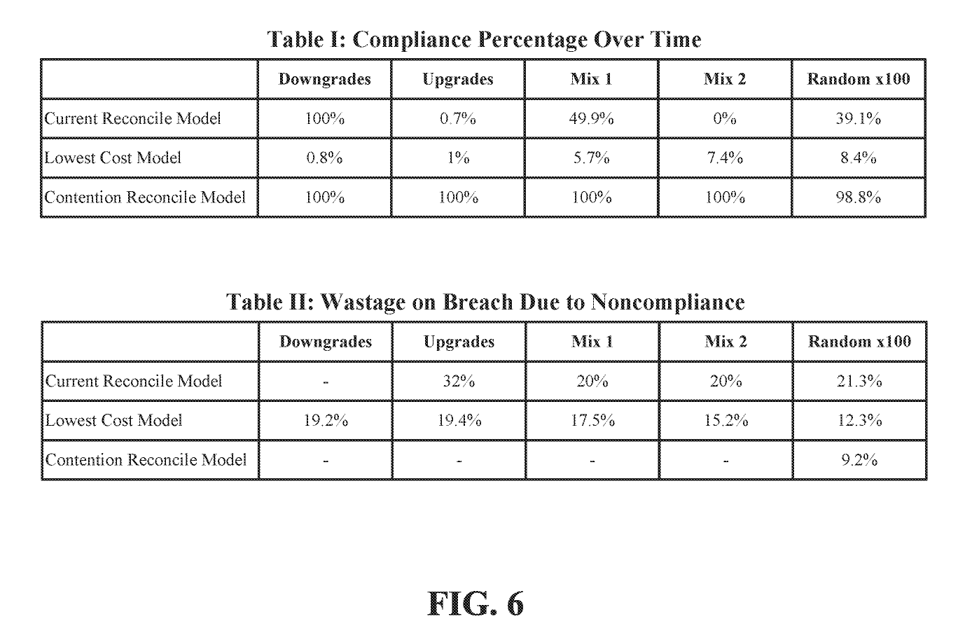

As shown in FIG. 6, three different optimization models were tested. Two of these models (i.e., the current reconcile model and the lowest cost model) are commonly used for software asset management and compliance optimization. The third model (i.e., the contention reconcile model) utilizes the techniques described herein. More specifically, the contention reconcile model balances the contention of each entitlement and the need of each possible installation assignment in order to discover the optimal compliant license position. Not only does the contention reconcile model ensure nearly continuous license compliance under every scenario (see Table I), but it also allows the licensee to minimize wastage on breach due to noncompliance (see Table II).

### Processing System

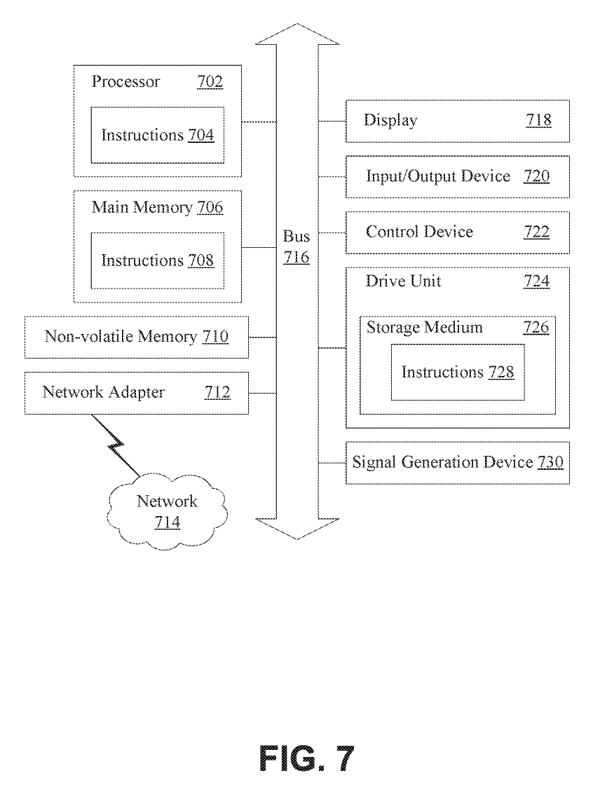

FIG. 7 is a block diagram illustrating an example of a processing system 700 in which at least some operations described herein can be implemented. For example, the processing system 700 may be responsible for assigning installations to entitlements or monitoring compliance of a licensee. The computing system may include one or more central processing units (“processors”) 702, main memory 706, non-volatile memory 710, network adapter 712 (e.g., network interfaces), display 718, input/output devices 720, control device 722 (e.g., keyboard and pointing devices), drive unit 724 including a storage medium 726, and signal generation device 730 that are communicatively connected to a bus 716. The bus 716 is illustrated as an abstraction that represents any one or more separate physical buses, point to point connections, or both connected by appropriate bridges, adapters, or controllers. The bus 716, therefore, can include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire.”

In various embodiments, the processing system 700 operates as a standalone device, although the processing system 700 may be connected (e.g., wired or wirelessly) to other machines. For example, the processing system 700 may include a terminal that is coupled directly to licensing server of a licensee. As another example, the processing system 700 may be wirelessly coupled to the licensing server.

In various embodiments, the processing system 700 may be a server computer, a client computer, a personal computer (PC), a user device, a tablet PC, a laptop computer, a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, or any machine capable of executing a set of instructions (sequential or otherwise) that specify actions to be taken by the computing system.

While the main memory 706, non-volatile memory 710, and storage medium 726 (also called a “machine-readable medium) are shown to be a single medium, the term “machine-readable medium” and “storage medium” should be taken to include a single medium or multiple media (e.g., a centralized or distributed database, and/or associated caches and servers) that store one or more sets of instructions 728. The term “machine-readable medium” and “storage medium” shall also be taken to include any medium that is capable of storing, encoding, or carrying a set of instructions for execution by the computing system and that cause the computing system to perform any one or more of the methodologies of the presently disclosed embodiments.

In general, the routines executed to implement the embodiments of the disclosure, may be implemented as part of an operating system or a specific application, component, program, object, module, or sequence of instructions referred to as “computer programs.” The computer programs typically comprise one or more instructions (e.g., instructions 704, 708, 728) set at various times in various memory and storage devices in a computer, and that, when read and executed by one or more processing units or processors 702, cause the processing system 700 to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include recordable type media such as volatile and non-volatile memory devices 710, floppy and other removable disks, hard disk drives, optical disks (e.g., Compact Disk Read-Only Memory (CD ROMS), Digital Versatile Disks (DVDs)), and transmission type media such as digital and analog communication links.

The network adapter 712 enables the processing system 700 to mediate data in a network 714 with an entity that is external to the processing system 700 through any known and/or convenient communications protocol supported by the processing system 700 and the external entity. The network adapter 712 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 712 can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

As indicated above, the techniques introduced here implemented by, for example, programmable circuitry (e.g., one or more microprocessors), programmed with software and/or firmware, entirely in special-purpose hardwired (i.e., non-programmable) circuitry, or in a combination or such forms. Special-purpose circuitry can be in the form of, for example, one or more application-specific integrated circuits (ASICs), programmable logic devices (PLDs), field-programmable gate arrays (FPGAs), etc.

Note that any of the embodiments described above can be combined with another embodiment, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

1. A computer-implemented method for discovering an optimal compliant position of a software licensee having multiple entitlements corresponding to software resources, the method comprising:
determining, by a compliance platform, a count of possible assignments for each entitlement of the multiple entitlements,
wherein the possible assignments represent installation locations available to a corresponding entitlement;
calculating, by the compliance platform, contention for each entitlement, where contention is calculated by dividing the count of possible assignments for a given entitlement by an entitlement quantity;
ranking, by the compliance platform, the multiple entitlements by contention;
processing, by the compliance platform, the multiple entitlements in ascending order of contention;
for each entitlement,
calculating, by the compliance platform, need of each possible assignment of the possible assignments,
where need is calculated by dividing the entitlement quantity required by a given possible assignment a number of applicable entitlements having the entitlement quantity available;
arranging, by the compliance platform, the possible assignments in a queue in descending order of need;
producing, by the compliance platform, an assignment set that represents the optimal compliance position for the software licensee by processing a subset of assignments from the queue in descending order of need;
transmitting, by the compliance platform, the assignment set to a licensing server associated with the software licensee that includes the software resources corresponding to the multiple entitlements,
where the compliance platform is communicatively coupled to the licensing server across a network; and
adapting priority of the multiple entitlements, the possible assignments, or both to make better use of computer system resources responsive to a condition affecting the assignment set.

2. The computer-implemented method of claim 1, wherein processing the subset of assignments from the queue in descending order of need causes those assignments having the highest need to be made first.

3. The computer-implemented method of claim 1, wherein the possible assignments include single installations, multiple-use assignments, or a combination thereof.

4. The computer-implemented method of claim 1, wherein the possible assignments represent all possible assignments for each software installation.

5. The computer-implemented method of claim 1, wherein processing the multiple entitlements in ascending order of contention causes those entitlements having the lowest contention to be processed first.

6. The computer-implemented method of claim 1, further comprising:
removing, by the compliance platform, an assignment from the queue that has at least one software installation in common with the subset of assignments; and
assigning, by the compliance platform, the assignment to a particular entitlement having a lowest noncompliance cost.

7. The computer-implemented method of claim 6, wherein assigning the assignment to the particular entitlement having the lowest noncompliance cost causes noncompliance with a software license, but limits noncompliance to the particular entitlement at the lowest noncompliance cost.

8. A method for discovering a compliant position of a software licensee having multiple entitlements, the method comprising:
determining, by a network-connected compliance platform, a count of all possible assignments within a network associated with the software licensee for each entitlement of the multiple entitlements;
calculating, by the network-connected compliance platform, contention for each entitlement by dividing the count of possible assignments for each entitlement by a count of the multiple entitlements;
ranking, by the network-connected compliance platform, the multiple entitlements by contention; and
processing, by the network-connected compliance platform, the multiple entitlements in ascending order of contention,
wherein said processing causes those entitlements having the lowest contention to be processed first.

9. (canceled)

10. The method of claim 8, further comprising:
for each entitlement,
calculating, by the network-connected compliance platform, need of each possible assignment
by dividing entitlement quantity required by each possible assignment by a number of applicable entitlements having the entitlement quantity available.

11. The method of claim 10, further comprising:
arranging, by the network-connected compliance platform, the possible assignments in a queue in descending order of need;
producing, by the network-connected compliance platform, an assignment set that represents the compliant position for the software licensee by processing a subset of assignments from the queue in descending order of need; and
transmitting, by the network-connected compliance platform, the assignment set to a licensing server that includes software assets corresponding to the multiple entitlements.

12. The method of claim 11, further comprising:
removing, by the network-connected compliance platform, an assignment from the queue that has at least one software installation in common with the subset of assignments; and
assigning, by the network-connected compliance platform, the assignment to a particular entitlement having a lowest noncompliance cost.

13. The method of claim 12, wherein assigning the assignment to the particular entitlement having the lowest noncompliance cost causes noncompliance with a software license, but limits noncompliance to the particular entitlement at the lowest noncompliance cost.

14. The method of claim 8, wherein the possible assignments include single installations and multiple-use assignments.

15. A network-accessible platform for optimizing compliance of a software licensee having multiple entitlements, the platform comprising:
a processor; and
a memory that includes instructions that, when executed by the processor, cause the processor to:
determine a count of possible assignments for each of the multiple entitlements;
calculate a contention value for each entitlement,
where contention is based at least in part on the count of possible assignments and entitlement quantity;
rank the multiple entitlements based on the contention values;
process the multiple entitlements in ascending order of contention;
for each entitlement,
calculate a need value for each of the possible assignments,
where need is based at least in part on entitlement quantity required by each assignment and a number of applicable entitlements having the entitlement quantity available; and
process some or all of the possible assignments in descending order of need.

16. The network-accessible platform of claim 15, wherein the instructions further cause the processor to:
arrange the possible assignments in a queue in descending order of need.

17. The network-accessible platform of claim 15, wherein said processing the some or all of the possible assignments in descending order of need causes an assignment set to be produced that represents an optimal compliant position for the software licensee.

18. The network-accessible platform of claim 17, wherein the instructions further comprise:
transmitting an indication of the processed assignments to a license server.

19. The network-accessible platform of claim 18, wherein the license server is managed by an enterprise licensee.

20. The network-accessible platform of claim 16, wherein the instructions further cause the processor to:
remove an assignment from the queue that has at least one software installation in common with the processed assignments; and
assign the assignment to a particular entitlement having a lowest noncompliance cost.

21. The computer-implemented method of claim 1, further comprising:
determining, by the compliance platform, a compliance status of the software licensee by continually monitoring usage of software assets corresponding to the assignment set by one or more computing devices associated with the software licensee.
